(19) United States
(12) Patent Application Publication
(10) Pub. No.: US 2016/0307000 A1
(43) Pub. Date: Oct. 20, 2016

(54) INDEX-SIDE DIACRITICAL CANONICALIZATION

(71) Applicants: Phuong B. Nguyen, Milpitas, CA (US); Dimitra Papachristou, Palo Alto, CA (US)

(72) Inventors: Phuong B. Nguyen, Milpitas, CA (US); Dimitra Papachristou, Palo Alto, CA (US)

(21) Appl. No.: 12/942,967

(22) Filed: Nov. 9, 2010

(51) Int. Cl. G06F 17/30

(52) U.S. Cl. CPC G06F 21/64

(57) ABSTRACT

Methods, systems, and apparatus, including computer programs encoded on computer storage media, for index-side synonym expansion. One method includes obtaining a token sequence for a resource and indexing a particular token in the token sequence. The indexing includes obtaining a diacritically canonicalized form of the particular token; determining that the diacritically canonicalized form of the particular token is different from the particular token; and storing data associating the resource with both the particular token and the different diacritically canonicalized form of the particular token as index terms for the resource in a search engine.

### BACKGROUND

This specification relates to identifying resources relevant to search queries submitted to a search engine.

Search engines identify digital resources (e.g., Web pages, images, text documents, multimedia content) that are responsive to search queries, and provide information on the identified resources. In general, search engines match terms of the search queries to terms in the resources or metadata associated with the resources to determine which resources are responsive to which queries.

Multiple words can be used to describe a similar concept (for example, “car,” “cars,” “automobile,” and “automobiles”). The word used in or to describe a particular resource may not exactly match the word used in a search query. Therefore, to identify additional resources relevant to search queries, some conventional search engines perform query expansion, augmenting search queries with synonyms for words in the queries. For example, a search query for “red car” could be augmented to be “red (car OR cars OR automobile OR automobiles),” because “car,” “cars,” “automobile,” and “automobiles” have similar meanings However, because search queries often include multiple terms, and each term in a search query can have multiple synonyms, it can be difficult to add all relevant synonyms to a received search query.

### SUMMARY

This specification describes technologies relating to indexing resources and identifying resources responsive to user search queries.

To reduce the amount of query expansion that needs to be done, a search system augments its search index with synonyms for words found in resources. Specifically, the search system adds diacritically canonicalized forms of words to a search engine index. The search system then augments received queries with information needed to match the augmented index.

In general, one innovative aspect of the subject matter described in this specification can be embodied in methods that include the actions of obtaining a token sequence for a resource; indexing a particular token in the token sequence, the indexing comprising: obtaining a diacritically canonicalized form of the particular token; determining that the diacritically canonicalized form of the particular token is different from the particular token; and storing data associating the resource with both the particular token and the different diacritically canonicalized form of the particular token as index terms for the resource in a search engine. Other embodiments of this aspect include corresponding systems, apparatus, and computer programs recorded on computer storage devices, each configured to perform the operations of the methods.

These and other embodiments can each optionally include one or more of the following features. The token sequence comprises tokens extracted from the resource or from metadata for the resource. The actions further comprise storing data in the search engine index that indicates that the diacritically canonicalized form of the particular token is a diacritically canonicalized form. Storing data indicating that the diacritically canonicalized form is a diacritically canonicalized form of the particular token comprises adding a prefix identifying the diacritically canonicalized form as a diacritically canonicalized form before associating the resource with the diacritically canonicalized form.

The actions further comprise receiving a search query comprising one or more tokens; identifying a first token in the search query, wherein the first token comprises one or more characters with diacritical marks; obtaining a diacritically canonicalized form of the first token; and augmenting the search query to include the diacritically canonicalized form of the first token. The actions further comprise determining that the diacritically canonicalized form of the first token is different from the first token; and augmenting the search query comprises augmenting the search query to include both (i) the diacritically canonicalized form of the first token and (ii) the diacritically canonicalized form of the first token with information identifying the diacritically canonicalized form as a diacritically canonicalized form. The actions further comprise determining that the diacritically canonicalized form of the first token is the same as the first token; and augmenting the search query comprises augmenting the search query to include the diacritically canonicalized form of the first token with information identifying the diacritically canonicalized form of the first token as a diacritically canonicalized form. The actions further comprise assigning a weight to each token in the augmented search query, including assigning a weight to the diacritically canonicalized form so that resources matching the first token in the search query are weighted more highly than resources matching only the diacritically canonicalized form of the token.

Obtaining the diacritically canonicalized form of the particular token comprises applying one or more rules that map one or more characters with a diacritical mark to one or more characters without any diacritical marks. The actions further comprise determining a language of the resource, wherein the one or more rules are specific to the language. Obtaining the diacritically canonicalized form of the particular token comprises: applying one or more rules to generate a particular standard form of the particular token; obtaining the diacritically canonicalized form of the token, wherein the diacritically canonicalized form of the token is a pre-selected representative token in a group of tokens have a standard form matching the particular standard form. The particular token has one or more characters with a diacritical mark, and the diacritically canonicalized form of the particular token has no characters with any diacritical marks. The diacritically canonicalized form of the particular token has one or more characters with a diacritical mark.

Particular embodiments of the subject matter described in this specification can be implemented so as to realize one or more of the following advantages. Resources responsive to search queries can be identified, even when the resources do not contain the exact words used in the search queries. Resources responsive to search queries can be identified without adding a large number of synonyms to search queries.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example prior art search system for providing search results relevant to submitted queries.

FIG. 2 illustrates an example search system with an index augmented with diacritically canonicalized forms of tokens.

FIG. 3 is a flow chart of an example method for augmenting an index with diacritically canonicalized forms of tokens.

FIG. 4 is a flow chart of an example method for augmenting a query with information needed to retrieve information from an index augmented with diacritically canonicalized forms of tokens in resources.

Like reference numbers and designations in the various drawings indicate like elements.

### DETAILED DESCRIPTION

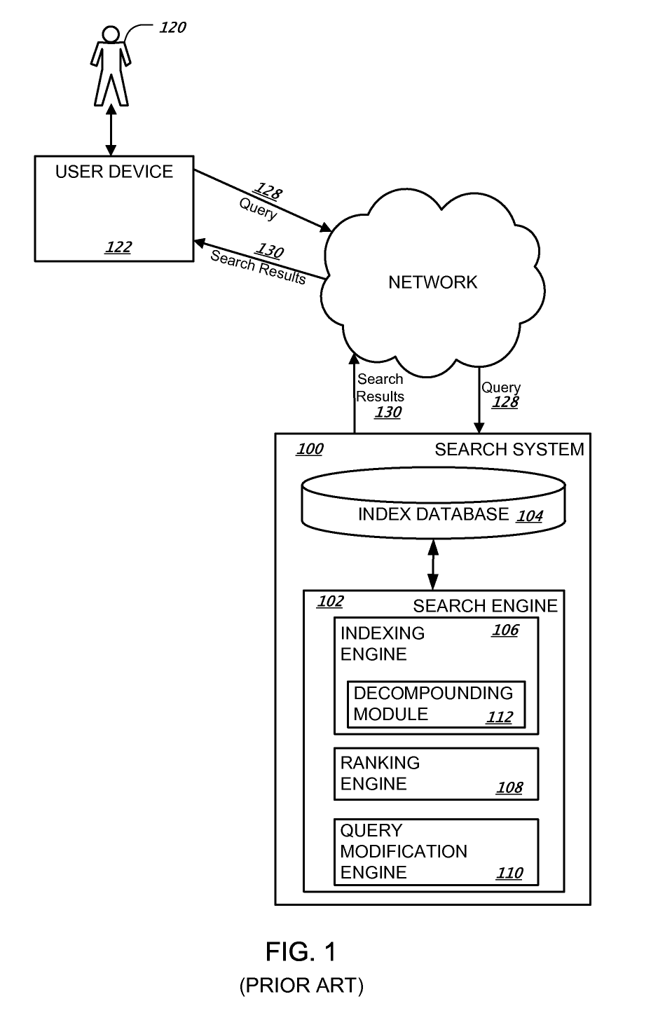

FIG. 1 illustrates an example prior art search system 100 for providing search results relevant to submitted queries as can be implemented in an Internet, an intranet, or another client and server environment. The search system 100 can be implemented as, for example, computer programs running on one or more computers in one or more locations that are coupled to each other through a network.

The search system 100 includes a search engine 102 and an index database 104. The search engine 102 includes an indexing engine 106 that indexes resources found in a corpus, a ranking engine 108, or other software to rank the resources that match user queries, and a query modification engine 110 to modify queries received from users. A corpus is a collection or repository of resources. Resources are, for example, web pages, images, or news articles. In some implementations, resources are resources on the Internet.

The ranking engine 108 ranks the resources that match user queries. The ranking engine 108 ranks the resources, for example, using conventional techniques.

The indexing engine 106 receives information about the contents of resources, e.g., tokens appearing in the resources that are received from a web crawler, and indexes the resources by storing index information in the index database 104. While one index database 104 is shown in FIG. 1, in some implementations, multiple index databases 104 can be built and used. The indexing engine 106 indexes the contents of resources, for example, using conventional techniques and using a decompounding module 112.

The decompounding module 112 identifies compound tokens in the text of resources and decompounds the compound tokens. For example, the decompounding module 112 can decompound a compound token, resulting in two or more decompounded tokens. The decompounding module 112 then stores data associating each of the decompounded tokens with the appropriate resources. A token is a string of characters separated from other characters by white space, e.g., spaces, tabs or hard returns, or punctuation. A compound token is a token containing two or more sub-tokens each having semantic meaning For example, if a resource contained the token “firehouse,” the decompounding module would associate the resource with the tokens “fire” and “house” in the index database 104. The decompounding module 112 identifies and decompounds compound tokens, for example, using conventional methods. If a compound can be decompounded in multiple ways, the decompounding module 112 can associate all of the possible decompounded tokens with the resource in the index database 104. For example, if the compound “useswords” appears in the index, the decompounding module 112 can associate the decompounded tokens “use” and “swords” as well as the decompounded tokens “uses” and “words” with the resource in the index.

In some implementations, the indexing engine 106 and the decompounding module 112 associate a resource with both the compound token and its corresponding decompounded tokens. For example, a resource containing the token “firehouse” would be associated with the tokens “firehouse,” “fire,” and “house” in the index database 104. In some implementations, the decompounding module 112 also stores data associating the decompounded tokens with the compound token from which they were identified. For example, “fire” and “house” could be associated with the token “firehouse.” The decompounding module 112 can also store data indicating the order of the tokens in the compound, e.g., data indicating that “fire” came before “house” in the compound token “firehouse.”

In some implementations, the decompounding module 112 also stores data in the index that identifies each decompounded token as having been identified from a compound token in a resource. For example, the decompounding module 112 can add a prefix to each decompounded token that identifies the token as having been identified from a compound token in the resource.

A user 120 interacts with the search system 100 through a user device 122. For example, the device 122 can be a computer coupled to the search system 100 through a local area network (LAN), a wide area network (WAN), e.g., the Internet, or a wireless network, or a combination of them. In some implementations, the search system 100 and the user device 122 can be the same computer. For example, a user can install a desktop search application on the user device 122. The user device 122 will generally be a computer.

When the user 120 submits a query 128 to the search engine 102 within the search system 100, the query 128 is transmitted through a network, if necessary, to the search engine 102.

The search engine modifies the query using the query modification engine 110 as appropriate. In implementations where decompounded tokens are marked in the index database to distinguish them from tokens in their original form, the query modification engine 110 modifies the query to include both the tokens of the query and the tokens of the query with data identifying them as decompounded tokens. For example, if a user searches for “ fire fighter station,” the query modification engine could modify the query to be “(fire OR*dc*fire) (fighter OR*dc*fighter) (station OR *dc*station),” where “*dc*” is the prefix used to denote decompounded tokens that appear in the resource as part of a longer compound token. The query modification engine 110 can also make other conventional modifications to the query.

In some implementations, before modifying the query, the query modification engine 110 determines whether to modify the query, for example, by evaluating one or more criteria. For example, the query modification engine 110 can determine whether the query is longer than one word and is expected to get less than a threshold number of results. If so, the query modification engine 110 modifies the query; otherwise, the query modification engine does not modify the query. As another example, the query modification engine 110 can determine whether a particular token is an entity name, e.g., by comparing the token to a list of known entity names. The query modification engine 110 can then only add the token, with data identifying the token as a decompounded token, to the query when the token is not an entity name.

The search engine 102 uses the index database 104 to identify resources that match the tokens of the modified query. The search engine 102 transmits search results 130 identifying the highest-ranked matching resources through the network to the user device 122, for example, for presentation to the user 120 (e.g., in a search results web page that is displayed in a web browser running on the user device 122).

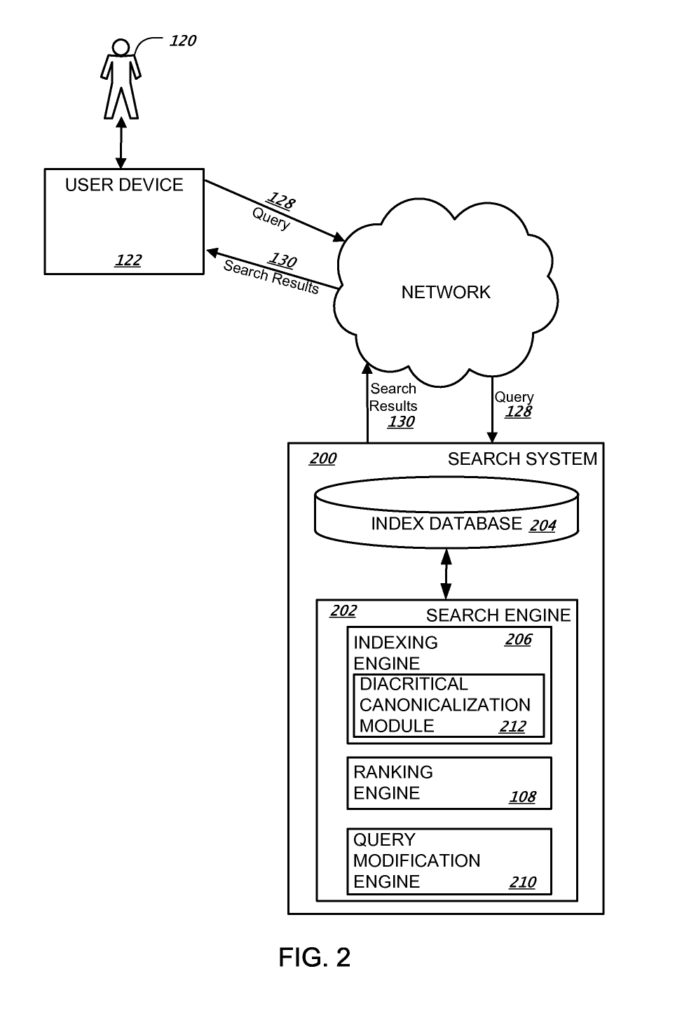

FIG. 2 illustrates an example search system 200 with an augmented index database 204. While a single index database 104 is shown in FIG. 2, in some implementations, multiple index databases can be built and used using the methods described below.

Like the prior art search system 100 described above with reference to FIG. 1, the search system 200 provides search results relevant to submitted queries and can be implemented in an Internet, an intranet, or other client and server environment. However, the search system 200 differs from the prior art search system 100 described above with reference to FIG. 1 in at least two ways.

First, instead of a decompounding module 112, the search system 200 has a diacritical canonicalization module 212. The diacritical canonicalization module 212 adds additional information to the index database 204 other than decompounded versions of tokens found in resources.

Second, the query modification engine 210 in the system 200 modifies queries differently than the query modification engine 110 does. Both of these differences will be described in more detail below.

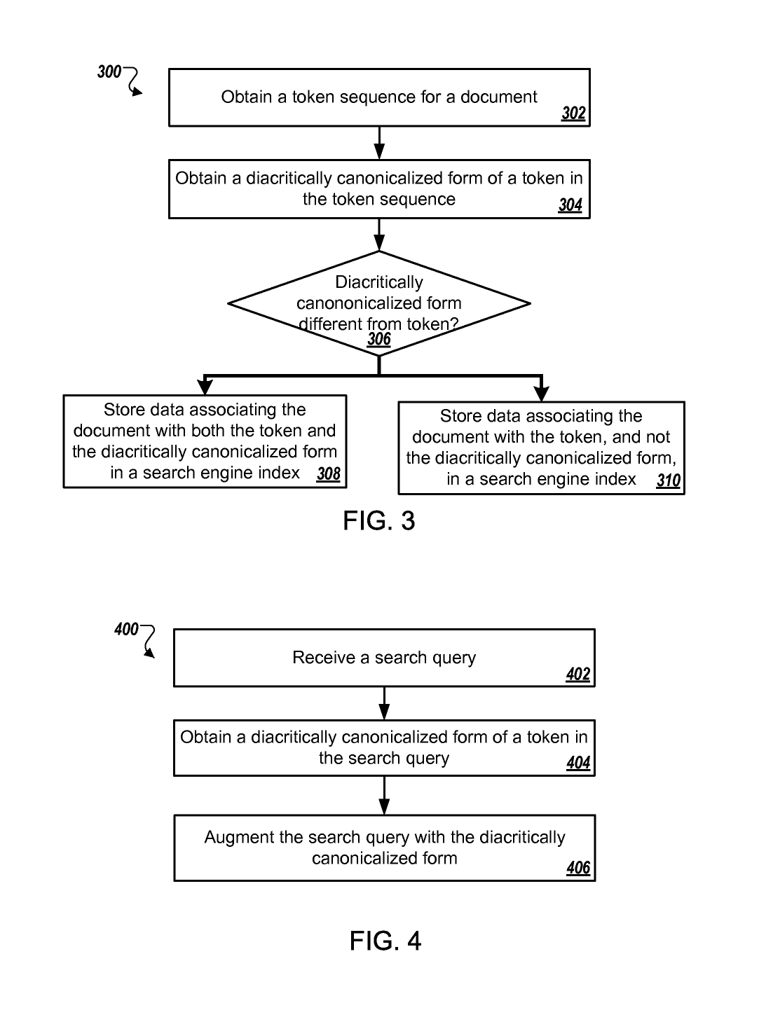

The diacritical canonicalization module 212 processes the text of resources and resource metadata to generate a diacritically canonicalized form of each of one or more the tokens in the resources or in the resource metadata and add the diacritically canonicalized forms to the index database 204. Adding diacritically canonicalized forms of tokens to the index database 204 is described in more detail below with reference to FIG. 3.

The query modification engine 210 modifies queries as needed to take advantage of the additional information stored by the index augmentation module 212 in the index database 204. Query modifications that are made when the index augmentation module 212 adds diacritically canonicalized forms of tokens to the index database 204 are described in more detail below with reference to FIG. 4.

FIG. 3 is a flow chart of an example method 300 for augmenting an index with diacritically canonicalized forms of tokens. For convenience, the method 300 is described in reference to a system of one or more computers that performs the steps of the method. The system can be, for example, the search system 200 described above with reference to FIG. 2.

The system obtains a token sequence for a resource (302). The token sequence is made up of tokens extracted from the resource or metadata for the resource. In some implementations, the tokens in the token sequence are ordered, e.g., according to their relative positions in the resource. For example, a resource containing the phrase “I love puppies—they are adorable” would have the ordered token sequence [“I” “love” “puppies” “they” “are” “adorable”]. The sequence of tokens can be obtained, for example, from a web crawler that is part of the system, or from a separate system.

In some cases, some of the tokens have one or more characters with diacritical marks. Example characters with diacritical marks include é (with a diacritical accent mark), ä (with a diacritical umlaut mark), and ñ (with a diacritical tilde mark).

The system then indexes the tokens in the token sequence. For at least one token in the token sequence, the system performs the following steps to index the token. In some implementations, the system performs the following steps to index each token in the token sequence.

The system obtains a diacritically canonicalized form of the token (304). The diacritically canonicalized form of the token is a form of the token that results from applying one or more diacritical normalization rules to the token. These rules specify allowable substitutions of one or more characters for one or more other characters. The rules can be generated, for example, using conventional techniques.

In some implementations, one or more of the diacritical normalization rules are language specific. For example, the rule (“ä” “a”) is valid in all languages except German. In German, the rule is (“ä” “ae”). In these implementations, when indexing a resource, the system determines the language of the resource and uses rules appropriate to the language of the resource. Similarly, when augmenting a query as described in more detail below with reference to FIG. 4, the system determines the language of the query and uses rules appropriate to the language of the query. In some implementations, the rules are generated as described in U.S. patent application Ser. No. 11/408,242, filed on Apr. 19, 2006, which is incorporated herein by reference.

In some implementations, the system generates the diacritically canonicalized form of the token by applying one or more rules that map characters with diacritical marks to characters without diacritical marks. In some implementations, the diacritically canonicalized form of the token does not have any diacritical marks. In some implementations, the diacritically canonicalized form of the token has one or more characters with a diacritical mark. For example, the rules can map each character to the most frequently occurring form of the character in a group of resources, e.g., the resources being indexed.

For example, if “é” appears more frequently than “e” in the group of resources, then the rules will map “e” to “ä” Conversely, if “e” appears more frequently than “ä” in the group of resources, then the rules will map “ä” to “e.”

In some implementations, the system applies the one or more rules to generate a standard form of the token, and then selects the diacritically canonicalized form of the token from a group of tokens that each have the standard form. In some implementations, the diacritically canonicalized form is a pre-selected representative token from the group of tokens. For example, the pre-selected representative token can be the token in the group of tokens that appears the most frequently in a group of resources such as the resources being indexed.

The system determines whether the diacritically canonicalized form of the token is different from the token (306).

If the token and the diacritically canonicalized form of the token are different, the system stores data associating the resource with both the token and the diacritically canonicalized form of the token in a search engine index (308). The token and the diacritically canonicalized form of the token are stored as index terms for the resource. For example, the system can store information in an index database such as the index database 204 described above with reference to FIG. 2. In some implementations, the system denotes the diacritically canonicalized form in the index, for example, by storing data indicating that the diacritically canonicalized form is derived from a token in the resource but was not the actual token in the resource. For example, the system can add a prefix to the diacritically canonicalized form that indicates that it is a diacritically canonicalized form before associating the diacritically canonicalized form with the resource. In some cases, the diacritically canonicalized form of the token does not appear anywhere in the resource.

In some implementations, the system further associates the token with the diacritically canonicalized form of the token in the index. For example, the system can store data indicating that the token and the diacritically canonicalized form of the token correspond to the same token in the resource.

If the token and the diacritically canonicalized form of the token are the same, the system can store data associating the token with the resource and not store separate data associating the diacritically canonicalized form of the token with the resource (310). This can save space in the search engine index by avoiding duplicate associations. When the diacritically canonicalized form of the token is the most common form of the word in the resources being indexed, this can result in significant saved space.

FIG. 4 is a flow chart of an example method 400 for augmenting a query with information needed to retrieve information from an index augmented with diacritically canonicalized forms of tokens in resources. For convenience, the method 400 is described in reference to a system of one or more computers that performs the steps of the method. The system can be, for example, the search system 200 described above with reference to FIG. 2.

The system receives a search query (402), for example, as described above with reference to FIG. 1. The system performs the following steps for one or more of the tokens in the search query. The system obtains a diacritically canonicalized form of a token in the search query (404), for example, as described above with reference to FIG. 3. The system augments the search query with the diacritically canonicalized form (406). This augmentation causes the search engine to identify resources matching the tokens of the query, or the diacritically canonicalized form, as responsive to the query.

If the diacritically canonicalized form of the token is different from the token in the search query, the system augments the search query by adding the diacritically canonicalized form to the search query. If the search engine index denotes diacritically canonicalized forms, for example, using a prefix, the system can add both the diacritically canonicalized form, and the diacritically canonicalized form with the identifier that denotes it as being a diacritically canonicalized form, to the query. Consider an example where the search query is “räsumä John Doe,” the system is processing the token “räsumä,” and “resume” is the diacritically normalized form of “räsumä.” The system would modify the search query “räsumä John Doe,” to be “(räsumä OR resume OR *df*resume) John Doe,” where “*df*” is a prefix used to denote a diacritically canonicalized form of a token. If the query token is the same as the diacritically canonicalized form of the token, the system can just add the diacritically canonicalized form, with the information identifying the diacritically canonicalized form as being the diacritically canonicalized form, to the query, and not add the diacritically canonicalized form by itself. Consider an example where the search query is “resume John Doe,” the system is processing the token “resume,” and “resume” is the diacritically canonicalized form of “resume.” In this example, the system would modify the search query “resume John Doe” to be “(resume OR *df*resume) John Doe.” In some implementations, the system assigns weights to the tokens in the augmented query. For example, the system can assign less weight to the tokens added to the query than to the tokens in the received query to reflect the fact that diacritically normalized forms generally have at least slightly different meanings than their corresponding original tokens, and therefore may not be exactly what the user who submitted the search query intended. Consider an example where a first resource and a second resource are identical, except that the first resource contains the tokens in the received query and the second resource does not contain the tokens in the received query and instead contains another form of one of the tokens in the query that normalizes to the same diacritically canonicalized form. If the diacritically canonicalized tokens added to the query are assigned less weight than the tokens in the received query, the first resource will be ranked more highly than the second resource. In some implementations, the amount of the difference between the weights that the system assigns to the tokens added to the query and the tokens already in the query is derived from one or more factors of the query itself, for example, the length of the query. For example, the system can assign a greater difference in weights to tokens identified for shorter queries than to tokens identified for longer queries.

In some implementations, the amount of decrease in the weights for each token added to the query is determined, at least in part, from whether the meaning of the token will change if the diacritical marks in the token are changed. For example, the system can obtain a set of rules that specify which tokens that differ from a token only by diacritical changes are synonyms for the given token, and optionally a measure of difference of meaning between the given token and each of the other tokens. These rules can be obtained, for example, from an analysis of meaning of tokens with different diacritical marks. One example technique for determining whether the meaning of a word changes when certain diacritical changes occur, and an overall similarity score for two words that differ only in diacriticals, is described in U.S. patent application Ser. No. 12/568,435, filed Sep. 28, 2009, which is incorporated herein by reference. The system can use the rules to determine whether the meaning of the token is different from the meaning of other tokens having the same diacritical canonicalized form, in the aggregate. The system can then determine from this whether the meaning of the token is likely to change as a result of the diacritical canonicalizations, and by how much it is likely to change. The system can then assign decreases in weights based on (1) whether the meaning of the token is likely to change and (2) a measure of how much the meaning of the token is likely to change. For example, the system can assign larger decreases in weights to new tokens that are likely to change the meaning of the original query token than the system assigns to new tokens that are unlikely to change the meaning of the original query token.

In some implementations, before augmenting the query, the system determines whether the query should be augmented. For example, the system could evaluate a criterion that specifies that if the query only contains one token, the query should not be augmented. As another example, the system can evaluate a number of predicted results for the original query. If the number of predicted results satisfies a threshold, the system can determine not to augment the query. In such implementations, the system only augments the query if the result of the evaluation of the one or more criteria indicates that the query should be augmented. Alternatively or additionally, the system can evaluate one or more criteria regarding an individual token of the query to determine whether to add diacritically canonicalized forms of the individual token to the query. For example, the system can determine whether the token is a name of an entity, e.g., by comparing the token to a list of entity names, and can decide to not generate a canonically normalized form of the token if the token is an entity name. As another example, the system can evaluate a criterion that specifies that if a token has less than a threshold length, e.g., two characters, a diacritically canonicalized form of the token should not be added to the query.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1-30. (canceled)

31. A system comprising:
one or more computers programmed to perform operations comprising:
obtaining a sequence of tokens that occurs in a resource;
for each of one or more tokens in the sequence of tokens:
determining that a different, diacritically canonicalized, representative token has been pre-selected for the token, and
storing, in an index of index terms associated with the resource, (i) the token, and (ii) the different, diacritically canonicalized, representative token that has been pre-selected for the token, annotated with a prefix identifying the representative token as being derived from the token and not actually being the token; and
using, by a search engine, the index to identify the resource as responsive to a search query that includes the diacritically canonicalized, representative token.

32-50. (canceled)

51. The system of claim 31, wherein the token sequence comprises tokens extracted from the resource or from metadata for the resource.

52. The system of claim 31, wherein the operations further comprise storing data in the index of index terms that indicates that the different, diacritically canonicalized representative token is a diacritically canonicalized token.

53. The system of claim 52, wherein the data indicates that the representative token is not included in the sequence of tokens in the resource.

54. The system of claim 31, wherein the operations further comprise:
receiving a search query comprising one or more tokens;
identifying a first token in the search query, wherein the first token comprises one or more characters with diacritical marks;
determining whether a diacritically canonicalized representative token has been pre-selected for first token; and
augmenting the search query to include the diacritically canonicalized representative token for the first token.

55. The system of claim 54, wherein the operations further comprise augmenting the search query to include both (i) the diacritically canonicalized representative token for the first token and (ii) the diacritically canonicalized representative token for the first token with information identifying the diacritically canonicalized representative token as a diacritically canonicalized token.

56. The system of claim 54, wherein the operations further comprise assigning a weight to each token in the augmented search query, including assigning a weight to the diacritically canonicalized representative token so that resources matching the first token in the search query are weighted more highly than resources matching only the diacritically canonicalized representative token.

57. The system of claim 31, wherein the diacritically canonicalized representative token has no characters with any diacritical marks.

58. The system of claim 31, wherein an index term is a token associated with an indexed resource, and wherein the index term is used to identify indexed resources that include a match between the index term and a token of a query.

59. A computer-implemented method, comprising:
obtaining a sequence of tokens that occurs in a resource;
for each of one or more tokens in the sequence of tokens:
determining that a different, diacritically canonicalized, representative token has been pre-selected for the token, and
storing, in an index of index terms associated with the resource, (i) the token, and (ii) the different, diacritically canonicalized, representative token that has been pre-selected for the token, annotated with a prefix identifying the representative token as being derived from the token and not actually being the token; and
using, by a search engine, the index to identify the resource as responsive to a search query that includes the diacritically canonicalized, representative token.

60. The method of claim 59, wherein the token sequence comprises tokens extracted from the resource or from metadata for the resource.

61. The method of claim 59, further comprising storing data in the index of index terms that indicates that the representative token that is not included in the sequence of tokens is a diacritically canonicalized form.

62. The method of claim 61, wherein the data indicates that the representative token is not included in the sequence of tokens in the resource.

63. The method of claim 59, further comprising:
receiving a search query comprising one or more tokens;
identifying a first token in the search query, wherein the first token comprises one or more characters with diacritical marks;
determining whether a diacritically canonicalized representative token has been pre-selected for first token; and
augmenting the search query to include the diacritically canonicalized representative token for the first token.

64. The method of claim 63, further comprising augmenting the search query to include both (i) the diacritically canonicalized representative token for the first token and (ii) the diacritically canonicalized representative token for the first token with information identifying the diacritically canonicalized representative token as a diacritically canonicalized token.

65. The method of claim 63, wherein the operations further comprise assigning a weight to each token in the augmented search query, including assigning a weight to the diacritically canonicalized representative token so that resources matching the first token in the search query are weighted more highly than resources matching only the diacritically canonicalized representative token.

66. The method of claim 59, wherein the diacritically canonicalized representative token has no characters with any diacritical marks.

67. The method of claim 59, wherein an index term is a token associated with an indexed resource, and wherein the index term is used to identify indexed resources that include a match between the index term and a token of a query.

68. A non-transitory computer-readable medium storing software comprising instructions executable by one or more computers which, upon such execution, cause the one or more computers to perform operations comprising:
obtaining a sequence of tokens that occurs in a resource;
for each of one or more tokens in the sequence of tokens:
determining that a different, diacritically canonicalized, representative token has been pre-selected for the token, and
storing, in an index of index terms associated with the resource, (i) the token, and (ii) the different, diacritically canonicalized, representative token that has been pre-selected for the token, annotated with a prefix identifying the representative token as being derived from the token and not actually being the token; and
using, by a search engine, the index to identify the resource as responsive to a search query that includes the diacritically canonicalized, representative token.

69. The computer readable medium of claim 68, wherein an index term is a token associated with an indexed resource, and wherein the index term is used to identify indexed resources that include a match between the index term and a token of a query.
